(19) United States
(12) Patent Application Publication
(10) Pub. No.: US 2019/0020756 A1
(43) Pub. Date: Jan. 17, 2019

(54) SMART CALL CONNECTIVITY PREDICTION FOR ENHANCED USER EXPERIENCE

(71) Applicant: QUALCOMM Incorporated, San Diego, CA (US)

(72) Inventors: Vishnu Namboodiri KARAKKAD KESAVAN NAMBOODIRI, Hyderabad (IN); Rajesh GOPALA KRISHNAN, Hyderabad (IN); Ansah Ahmed SHEIK, Hyderabad (IN); Chinmaya PADHY, Koraput (IN)

(21) Appl. No.: 15/650,834

(22) Filed: Jul. 14, 2017

(51) Int. Cl. H04M 3/22; H04W 36/00; H04L 12/927

(52) U.S. Cl. CPC H04M 3/2227; H04L 41/14; H04L 47/805; H04W 36/0044

(57) ABSTRACT

The disclosure generally relates to providing a user with information regarding expected call connectivity and/or expected call quality prior to and/or during a call. For example, according to various aspects, a methodology that a wireless device can implement to predict call connectivity and/or quality may comprise measuring a current signal strength for at least one radio access technology (RAT) and mapping the current signal strength to a signal strength space division having multiple regions, wherein the multiple regions are each associated with an expected voice call connectivity and an expected data call connectivity. As such, user feedback information that indicates the expected voice call connectivity and the expected data call connectivity may be presented prior to receiving a request to initiate a call from the user.

### TECHNICAL FIELD

The various aspects and embodiments described herein generally relate to wireless communications, and more particularly, to a user equipment (UE) that can provide a user with information regarding expected call connectivity and/or expected call quality prior to and/or during a call.

### BACKGROUND

Wireless communications systems are widely deployed to provide various types of communication content such as voice, video, packet data, messaging, broadcast, and so on. These systems may be multiple-access communications systems that can support communication with multiple users through sharing available system resources (e.g., time, frequency, space and power). Examples of such multiple-access communications systems include code-division multiple access (CDMA) systems, time-division multiple access (TDMA) systems, frequency-division multiple access (FDMA) systems, and orthogonal frequency-division multiple access (OFDMA) systems. Generally, a wireless multiple-access communications system may include a number of base stations or access points, each simultaneously supporting communication for multiple wireless devices. Base stations or access points may communicate with wireless devices on downstream and upstream links. Each base station or access point has a coverage range, which may be referred to as the coverage area of the cell or access point.

While dealing with a user equipment (UE), such as a mobile phone device, users commonly experience poor call connectivity. Among other drawbacks, poor call connectivity can lead to frequent call drops, voice garbling, poor data speeds, and so on. In mobile communications (with around 2 GHz frequency), a minor variation of even one (1) centimeter can cause signal strength to change substantially. Nonetheless, there are no currently known mechanisms that provide a user with the ability to suitably predict or otherwise know the expected quality prior to the call except the antenna bar display. For example, one or more network providers may specify that antenna bars should be displayed based solely on a received signal strength indicator (RSSI) value, which in a UMTS network, would be displayed as shown in the following table:

TABLE 1
Example Antenna Bar Display Parameters

| RSSI Value | Antenna Bar Display |
|---|---|
| RSSI >= −55 dBm | Five Bars |
| −70 dBm <= RSSI < −55 dBm | Four Bars |
| −85 dBm <= RSSI < −70 dBm | Three Bars |
| −100 dBm <= RSSI < −85 dBm | Two Bars |
| RSSI < −100 dBm | One Bar |
| No Service | Antenna Icon Only |

For normal users, very little information about network conditions or likely call quality can be fetched from the above display. For example, the antenna bar display only considers signal strength and does not account for other network conditions, such as congestion, that could have an impact on call quality. Furthermore, although certain techniques to measure voice quality in a wireless communication network exist, the existing techniques tend to fall short from an end-user perspective. For example, in voice telephony, especially when codecs are used to compress the bandwidth requirement of a digitized voice connection, the Mean Opinion Score (MOS) provides a numerical indication of the perceived quality of received human speech over the connection. The MOS is typically expressed as a number in the range one (1) to five (5), where 1 is the lowest perceived quality and 5 is the highest perceived quality. Many different algorithms can be used to provide voice quality scores or measurements. For example, Single Sided Speech Quality Measure (“3SQM”), E-Model, Voice Quality Monitor (VQmon), Perceptual Evaluation of Speech Quality (PESQ), Perceptual Speech Quality Measure (PSQM); all of which are published and standardized by the International Telecommunications Union (ITU). However, the aforementioned voice quality measurement tests are limited in implementation to field tests, in which a field technician travels throughout the network to gauge the effectiveness of the network or as quality control tests on newly manufactured or repaired wireless devices. As such, the standard MOS used to indicate voice quality as-perceived by an average human listener is not usable at the end-user user perspective.

Accordingly, there exists a need to develop devices, apparatus, and methods to provide end users information regarding predicted call quality in a wireless network.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a user equipment may provide an end-user with information regarding expected call connectivity and/or an expected data rate prior to a call and/or during a call. For example, a voice call may be assumed to need a certain minimum signal strength to connect, wherein having a signal strength better than the required minimum may not substantially improve voice call connectivity and/or quality. Furthermore, standard mean opinion score (MOS) information can be used to measure voice call quality, whereas an expected data speed may vary according to signal strength. Accordingly, prior to a call, the signal strength may be used to derive information regarding whether a voice call and/or a data call will be able to be connected, while the standard MOS information may be used to indicate the expected quality associated with the voice call and the signal strength may be used to indicate the expected data rate (and thus the expected quality) associated with the data call. When the user equipment has multiple subscriber identity module (SIM) cards and knows the expected call quality before the call, the user may thereby select one particular SIM card based on the information indicating the predicted quality of service. Furthermore, the user may choose whether to initiate a voice call and/or a data call based on the expected connectivity associated with each and the expected quality associated with each.

According to various aspects, the user equipment may be configured to predict the expected connectivity associated with a voice call, the expected quality associated with the voice call, the expected connectivity associated with a data call, and the expected data rate associated with the data call based on a signal strength space divided into different regions. For example, in various embodiments, the signal strength space may be divided into the different regions based on various thresholds that are derived from known data and system analysis. As such, the user can be informed about the signal strength space division prior to the call and consider such information to select a given SIM card (assuming multiple SIM cards), attempt the call from a different location where call quality is predicted to better, avoid attempting a data call that may need higher quality of service (e.g., live streaming), not move locations while engaged in a call where the feedback says that the call will be dropped, etc.

According to various aspects, the user equipment may include an application configured to check the signal strength from one or more base stations using any suitable known or future-developed mechanisms (e.g., universal standards that may be defined with respect to one or more radio access technologies). The instantaneous value of the signal strength may be filtered over a short duration (e.g., a few seconds) and the value may be referenced in a mapping table that includes various boundaries/thresholds initialized with theoretical values. From the mapping table, the application may predict the expected voice quality as well as the expected data rate, which may be conveyed to the end-user through voice outputs, message interactions, or other suitable mechanisms. The user may make a decision based on the above input. Furthermore, as noted above, a user with a multi-SIM device may check the predictions for each SIM and choose one SIM to use accordingly. When the user actually makes the call, the application may learn the actual environment and the predicted thresholds may be recalibrated based on actual performance, which may make the predictions more accurate in the future. In addition, voice/display feedback can be given to the user during the call to enable the user to make decisions during the call (e.g., when a radio link failure timer has started).

According to various aspects, a method that a wireless device can implement to predict call connectivity and/or quality may comprise measuring a current signal strength for at least one radio access technology (RAT) and mapping the current signal strength to a signal strength space division having multiple regions, wherein the multiple regions are each associated with an expected voice call connectivity and an expected data call connectivity. As such, user feedback information that indicates the expected voice call connectivity and the expected data call connectivity may be presented prior to receiving a request to initiate a call from the user.

According to various aspects, a wireless device may comprise at least one radio frequency (RF) resource configured to measure a current signal strength for at least one radio access technology (RAT), at least one processor configured to map the current signal strength to a signal strength space division having multiple regions, wherein the multiple regions are each associated with an expected voice call connectivity and an expected data call connectivity, and at least one output device configured to present user feedback information that indicates the expected voice call connectivity and the expected data call connectivity, the user feedback information presented prior to receiving a request to initiate a call from the user.

According to various aspects, a wireless device may comprise means for measuring a current signal strength for at least one radio access technology (RAT), means for mapping the current signal strength to a signal strength space division having multiple regions, the multiple regions each associated with an expected voice call connectivity and an expected data call connectivity, and means for presenting user feedback information that indicates the expected voice call connectivity and the expected data call connectivity before receiving a request to initiate a call from the user.

According to various aspects, a computer-readable storage medium may have computer-executable instructions recorded thereon, wherein the computer-executable instructions may be configured to cause a wireless device to measure a current signal strength for at least one radio access technology (RAT), map the current signal strength to a signal strength space division having multiple regions, wherein the multiple regions are each associated with an expected voice call connectivity and an expected data call connectivity, and present user feedback information that indicates the expected voice call connectivity and the expected data call connectivity prior to receiving a request to initiate a call from the user.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary wireless communication system in which a user equipment (UE) may provide an end-user with information regarding expected call connectivity and/or an expected data rate, according to various aspects.

FIG. 2 illustrates an exemplary UE configured to provide information regarding expected call connectivity and/or an expected data rate, according to various aspects.

FIG. 3 illustrates an exemplary signal strength space division that can be used to derive information regarding expected call connectivity and/or an expected data rate, according to various aspects.

FIG. 4 illustrates an exemplary method to provide a user pre-call feedback regarding expected connectivity and/or expected quality, according to various aspects.

FIG. 5 illustrates an exemplary method to provide a user in-call feedback regarding expected connectivity and/or expected quality, according to various aspects.

FIG. 6 illustrates an exemplary mobile device that may be suitably used in accordance with the various aspects and embodiments described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user device,” “user equipment” (or “UE”), “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device. Accordingly, the above-mentioned terms may suitably refer to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar devices with at least one subscriber identity module (SIM), a programmable processor, memory, and circuitry to connect to and communicate over a radio access network (RAN) that implements a particular radio access technology (RAT), over a wired network, over a Wi-Fi network (e.g., based on IEEE 802.11, etc.), and/or with other devices via a direct device-to-device (D2D) or peer-to-peer (P2P) connection.

A UE may include one or more subscriber identity modules (SIMs) that provide access to one or multiple separate mobile communication networks that implement certain radio access technologies (RATs). Example UEs include, but are not limited to, mobile phones, laptop computers, smart phones, and other mobile communication devices of the like that are configured to connect to one or more RATs. Example RATs include, but are not limited to, Frequency Division Multiple Access (FDMA), Time Division Multiple Access (TDMA), Code Division Multiple Access (CDMA), Universal Mobile Telecommunications Systems (UMTS) (particularly, Wideband Code Division Multiple Access (WCDMA), Long Term Evolution (LTE), and the like), Global System for Mobile Communications (GSM), General Packet Radio Service (GPRS), Wi-Fi, Personal Communications Service (PCS), or other protocols that may be used in a wireless communications network or a data communications network.

In general, a UE that includes multiple SIMs and can be connected to two or more separate (or same) RATs using a same set of transmission hardware (e.g., radio-frequency (RF) transceivers) is a multi-SIM-multi-standby (MSMS) communication device. In one example, the MSMS communication device may be a dual-SIM-dual-standby (DSDS) communication device, which may include two SIM cards/subscriptions that may both be active on standby, but one is deactivated when the other one is in use. In another example, the MSMS communication device may be a triple-SIM-triple-standby (TSTS) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

On the other hand, a UE with multiple SIMs that can connect to two or more separate (or same) RATs using two or more separate sets of transmission hardware is termed a multi-SIM-multi-active (MSMA) communication device. An example MSMA communication device is a dual-SIM-dual-active (DSDA) communication device, which includes two SIM cards/subscriptions. Both SIMs may remain active. In another example, the MSMA device may be a triple-SIM-triple-active (TSTA) communication device, which includes three SIM cards/subscriptions. All three SIMs may remain active. In other examples, the MSMA communication device may be other suitable multi-SIM communication devices with four or more SIMs, which may all be active.

As used herein, the terms “SIM,” “SIM card,” “subscriber identity module,” and variants thereof are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” may also be used herein as a shorthand reference to the communication service associated with and enabled by the information stored in a particular SIM, as the SIM and the communication network (as well as the services and subscriptions supported by that network) correlate to one another.

Various aspects and embodiments described herein relate to, but are not limited to, a multi-SIM context such as the MSMS and MSMA contexts. For example, in the multi-SIM context, each subscription may be configured to acquire service from a base station (associated with a given cell). For clarity, various aspects and embodiments described herein refer to a UE with two subscriptions. However, a UE with only one SIM and one subscription may suitably implement various aspects and embodiments described herein, as can a UE with three or more SIMs and three or more subscriptions.

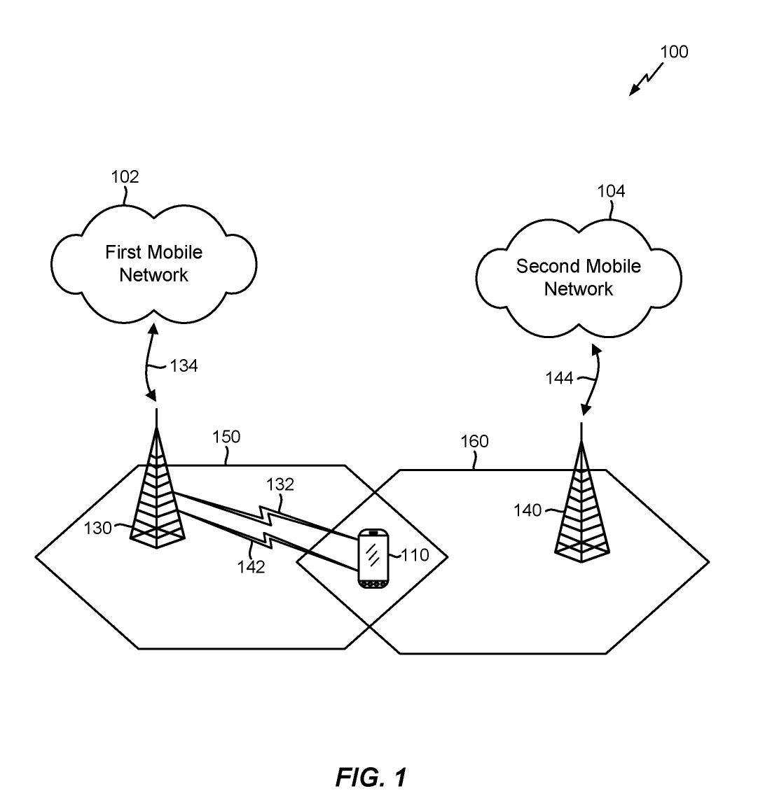

According to various aspects, FIG. 1 illustrates an exemplary wireless communication system 100 in which a user equipment (UE) 110 may provide an end-user with information regarding expected call connectivity and/or an expected data rate. In the example shown in FIG. 1, a first mobile network 102 and a second mobile network 104 each includes multiple base stations (e.g., a first base station 130 and a second base station 140). The first base station 130 may broadcast the first mobile network 102 in a first serving cell 150. The second base station 140 may broadcast the second mobile network 104 in a second serving cell 160. The UE 110 may acquire wireless service from either the first serving cell 150 or the second serving cell 160.

In various embodiments, the UE 110 may be in communication with the first mobile network 102 through a first wireless connection 132 to the first base station 130, which may correspond to a first subscription of the UE 110. The UE 110 may also be in communication with the first mobile network 102 through a second wireless connection 142 to the first base station 130, which may correspond to a second subscription of the UE 110, as in a multi-SIM context. For example, both the first subscription and the second subscription may locate a same serving cell (e.g., the first serving cell 150). The UE 110 may not be in communication with the second mobile network 104 through any wireless connection to the second base station 140. The first base station 130 may be in communication with the first mobile network 102 over a wired or wireless connection 134. The second base station 140 may be in communication with the second mobile network 104 over a wired or wireless connection 144.

In various embodiments, the first wireless connection 132 and the second wireless connection 142 may be made through two-way wireless communication links. Each of the wireless communication links may be enable by FDMA, TDMA, CDMA, UMTS (particularly, WCDMA, LTE, and the like), GSM, GPRS, Wi-Fi, PCS, or another protocol used in a wireless communications network or a data communications network. In various embodiments, the first wireless connection 132 and the second wireless connection 142 may each be associated with a different RAT. In other embodiments, the first wireless connection 132 and the second wireless connection 142 may be associated with the same RAT. The first base station 130 and the second base station 140 may each include at least one antenna group or transmission station located in the same or different areas. The at least one antenna group or transmission station may be associated with signal transmission and reception. The first base station 130 and the second base station 140 may each include one or more processors, modulators, multiplexers, demodulators, demultiplexers, antennas, and the like to perform the functions described herein. In various embodiments, the first base station 130 and the second base station 140 may be an access point, Node B, evolved Node B (eNode B or eNB), base transceiver station (BTS), or the like.

In various embodiments, the UE 110 may be configured to access the first mobile network 102 via a multi-SIM and/or a multi-mode SIM configuration (e.g., via the first wireless connection 132 and the second wireless connection 142). When a SIM corresponding to a subscription is received, the UE 110 may access the mobile communication network associated with that subscription based on the information stored on the SIM. While the UE 110 is shown connected to the mobile network 102 via two wireless connections, in various embodiments (not shown), the UE 110 may establish additional wireless connections associated with additional subscriptions corresponding to the mobile network 102 in a manner similar to those described above.

In various embodiments, the UE 110 may establish a wireless connection with a peripheral device (not shown) used in connection with the UE 110. For example, the UE 110 may communicate over a Bluetooth® link with a Bluetooth-enabled personal computing device (e.g., a “smart watch”). In various embodiments, the UE 110 may establish a wireless connection with a wireless access point (not shown), such as over a Wi-Fi connection. The wireless access point may be configured to connect to the Internet or another network over a wired connection.

According to various aspects, the UE 110 as shown in FIG. 1 may provide an end-user with information regarding expected call connectivity and/or an expected data rate prior to a call and/or during a call. For example, a voice call may be assumed to need a certain minimum signal strength (e.g., −85 dBm) to be connected, wherein having a signal strength better than the required minimum may not substantially improve voice call connectivity and/or quality. Furthermore, standard mean opinion score (MOS) information can be used to measure voice call quality, whereas an expected data speed may vary according to signal strength. Accordingly, prior to a call, the signal strength may be used to derive information regarding whether a voice call and/or a data call will be able to be connected, while the standard MOS information may be used to indicate the expected quality associated with the voice call and the signal strength may be used to indicate the expected data rate (and thus the expected quality) associated with the data call. When the UE 110 has multiple SIM cards and the user knows the expected call quality prior to the call, the user may thereby select one particular SIM card based on the information indicating the predicted quality of service. Furthermore, the user may choose whether to initiate a voice call and/or a data call based on the expected connectivity associated with each and the expected quality associated with each.

According to various aspects, the UE 110 may be configured to predict the expected connectivity associated with a voice call, the expected quality associated with the voice call, the expected connectivity associated with a data call, and the expected data rate associated with the data call based on a signal strength space divided into different regions. For example, in various embodiments, the signal strength space may be divided into the different regions based on various thresholds that are derived from known data and system analysis. As such, the user can be informed about the signal strength space division prior to the call and consider such information to select a given SIM card (assuming the UE 110 has multiple SIM cards), attempt the call from a different location where call quality is predicted to better, avoid attempting a data call that may need higher quality of service (e.g., live streaming), not move locations while engaged in a call where the feedback says that the call will be dropped, etc.

According to various aspects, the UE 110 may include an application configured to check the signal strength from the base stations 130, 140 (including respective signal strengths associated with the first and second wireless connections 132, 142) using any suitable known or future-developed mechanisms (e.g., universal standards that may be defined with respect to one or more radio access technologies). The instantaneous value of the signal strength may be filtered over a short duration (e.g., a few seconds) and the value may be referenced in a mapping table that includes various boundaries/thresholds initialized with theoretical values. From the mapping table, the application may predict the expected voice quality as well as the expected data rate, which may be conveyed to the end-user through voice outputs, message interactions, or other suitable mechanisms. The user may make a decision based on the above input. Furthermore, as noted above, a user with a multi-SIM device may check the predictions for each SIM and choose one SIM to use accordingly. When the user actually makes the call, the application may learn the actual environment and the predicted thresholds may be recalibrated based on actual performance, which may make the predictions more accurate in the future. In addition, voice/display feedback can be given to the user during the call to enable the user to make decisions during the call (e.g., when a radio link failure timer has started).

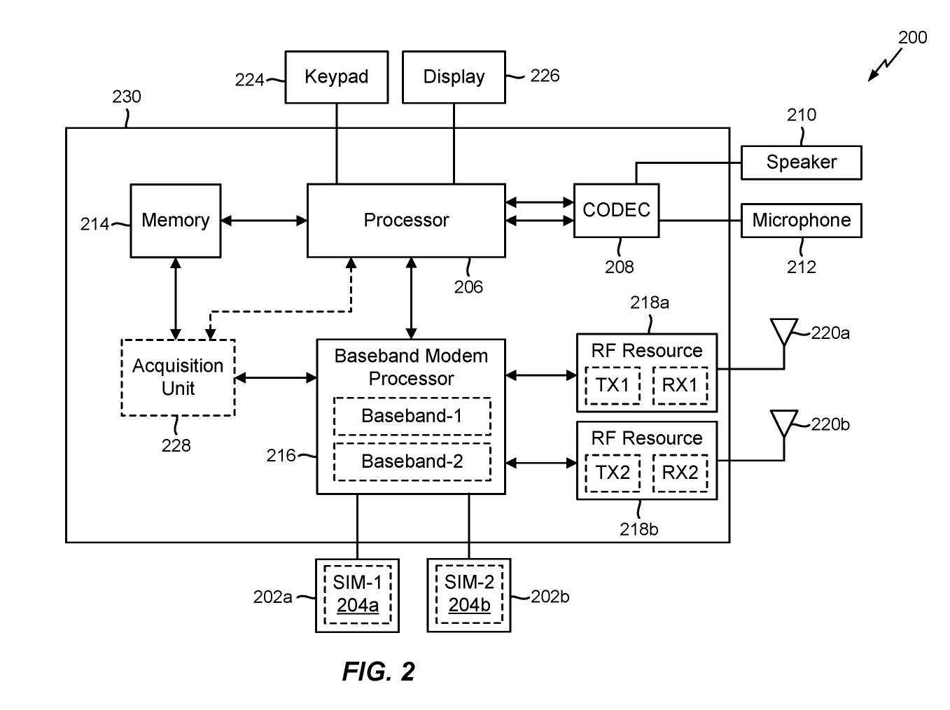

According to various aspects, FIG. 2 illustrates an exemplary UE 200 that can be configured to provide information regarding expected call connectivity and/or an expected data rate in accordance with various embodiments as described herein. In various embodiments, the UE 200 shown in FIG. 2 may represent one possible configuration for the UE 110 shown in FIG. 1 as described above.

In various embodiments, with particular reference to the example configuration shown in FIG. 2, the UE 200 may include a first SIM interface 202a, which may receive a first identity module SIM-1 204a associated with a first subscription. The UE 200 may also include a second SIM interface 202b, which may receive a second identity module SIM-2 204b associated with a second subscription. In various embodiments, the first subscription may be different from the second subscription. In other embodiments, the first subscription and the second subscription may be the same.

In various embodiments, the first SIM-1 204a and/or the second SIM-2 204b may be a Universal Integrated Circuit Card (UICC) configured with SIM and/or USIM applications, enabling access to GSM and/or UMTS networks. The UICC may also provide storage for a phone book and/or other suitable applications. Alternatively, in a CDMA network, a SIM may be a UICC removable user identity module (R-UIM) or a CDMA subscriber identity module (CSIM) on a card. The first SIM-1 204a and/or the second SIM-2 204b may have a CPU, ROM, RAM, EEPROM and I/O circuits. An Integrated Circuit Card Identity (ICCID) SIM serial number may be printed on the SIM card for identification. However, a SIM may be implemented in a portion of memory of the UE 200, and thus need not be a separate or removable circuit, chip, or card. A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

In various embodiments, the UE 200 may include at least one controller, such as a processor 206, which may be coupled to a coder/decoder (CODEC) 208. The CODEC 208 may in turn be coupled to a speaker 210 and a microphone 212. The processor 206 may also be coupled to at least one memory 214. The processor 206 may include any suitable data processing device, such as a microprocessor. In the alternative, the processor 206 may be any suitable electronic processor, controller, microcontroller, or state machine. The processor 206 may also be implemented as a combination of computing devices (e.g., a combination of a digital signal processor (DSP) and a microprocessor, a plurality of microprocessors, at least one microprocessors in conjunction with a DSP core, or any other such configuration).

In various embodiments, the memory 214 may be a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but are not limited to, random access memory RAM, read only memory ROM, floppy disks, hard disks, dongles or other recomp sensor board (RSB) connected memory devices, or the like. The memory 214 may store an operating system (OS), user application software, and/or executable instructions. For example, the instructions stored in the memory 214 may be configured to predict an expected call connectivity (e.g., with respect to a voice call and/or a data call) as well as an expected call quality (e.g., based on a mean opinion score (MOS) and/or an expected data rate based on a given signal strength parameter). The memory 214 may also store application data, such as an array data structure.

In various embodiments, the processor 206 and the memory 214 may each be coupled to at least one baseband modem processor 216. Each SIM in the UE 200 (e.g., the SIM-1 204a and the SIM-2 204b) may be associated with a baseband-RF resource chain. A baseband-RF resource chain may include the baseband modem processor 216, which may perform baseband/modem functions for communications on at least one SIM, and may include one or more amplifiers and radios, referred to generally herein as RF resources 218a, 218b (e.g., the first RF resource 218a and the second RF resource 218b). In various embodiments, baseband-RF resource chains may share the baseband modem processor 216 (i.e., a single device that performs baseband/modem functions for all SIMs on the UE 200). In other embodiments, each baseband-RF resource chain may include physically or logically separate baseband processors (e.g., BB-1, BB-2).

In various embodiments, the RF resources 218a, 218b may each be transceivers that perform transmit/receive functions for the associated SIMs 204a, 204b of the UE 200. The RF resources 218a, 218b may include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216. For simplicity, the first RF resource 218a (as well as the associated components) may be associated with the first subscription as enabled by the SIM-1 204a. For example, the first RF resource 218a may be configured to transmit/receive data via the first wireless connection 132. The second RF resource 218b may be associated with the second subscription as enabled by the SIM-2 204b. For example, the second RF resource 218b may be configured to transmit/receive data via the second wireless connection 142.

In various embodiments, the processor 206, the memory 214, the baseband processor(s) 216, and the RF resources 218a, 218b may be included in the UE 200 as a system-on-chip 230. In various embodiments, the first and second SIMs 204a, 204b and their corresponding interfaces 202a, 202b may be external to the system-on-chip 230. Further, various input and output devices may be coupled to components on the system-on-chip 230, such as interfaces or controllers. Example user input components suitable for use in the UE 200 may include, but are not limited to, a keypad 224, a touchscreen display 226, and the microphone 212.

In various embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the UE 200 to enable communication between them, as is known in the art.

In various embodiments, the UE 200 may include, among other things, additional SIM cards, SIM interfaces, RF resources associated with the additional SIM cards, and additional antennae for connecting to additional mobile networks.

In various embodiments, the UE 200 may include an acquisition unit 228 configured to manage and/or schedule utilization of the RF resources 218a, 218b for acquisition processes. For example, the acquisition unit 228 can be configured perform acquisition processes for the first subscription and the second subscription. In various embodiments, the acquisition unit 228 may be implemented within the processor 206. For example, the acquisition unit 228 may be implemented as a software application stored within the memory 214 and executed by the processor 206. Accordingly, such embodiments can be implemented with minimal additional hardware costs. However, other embodiments relate to systems and process that are implemented with dedicated device hardware specifically configured for performing operations described herein. For example, the acquisition unit 228 may be implemented as a separate hardware component (i.e., separate from the processor 206). The acquisition unit 228 may be coupled to the memory 214, the general processor 206, and/or the baseband processor 216 for performing the function described herein. The acquisition unit 228 may include (or coupled to) at least one of a radio resource control (RRC) layer, a radio resource management (RR) layer, a radio link control (RLC) layer, a media access control (MAC) layer, a physical layer, and the like.

Hardware and/or software for the functions may be incorporated in the UE 200 during manufacturing, for example, as part of the original equipment manufacturer (OEM) configuration of the UE 200. In further embodiments, such hardware and/or software may be added to the UE 200 post-manufacture, such as by installing one or more software applications onto the UE 200.

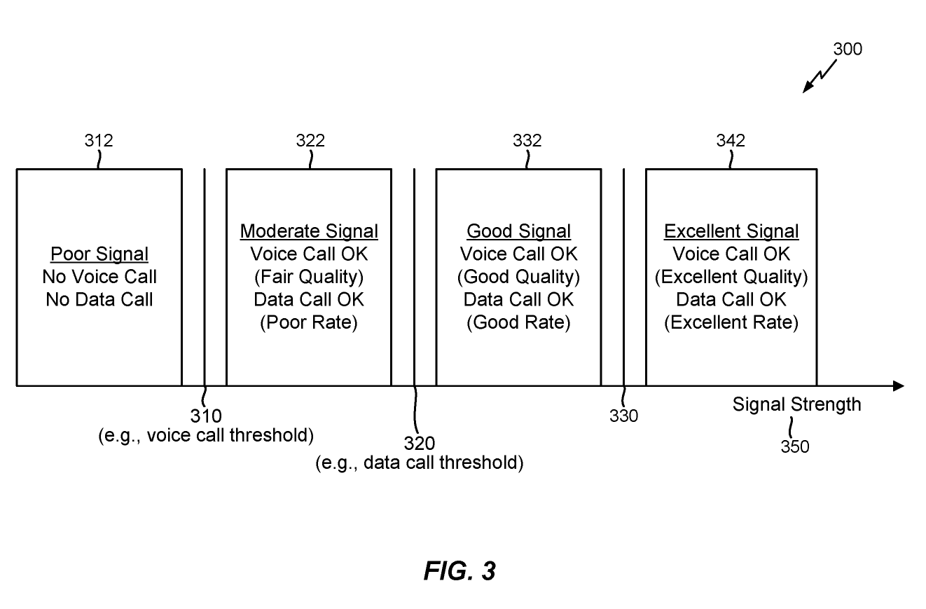

According to various aspects, as mentioned above, a UE 110 as shown in FIG. 1, a UE 200 as shown in FIG. 2, etc. may provide an end-user with information regarding expected call connectivity and/or an expected data rate prior to a call and/or during a call. For example, according to various embodiments, FIG. 3 illustrates an exemplary signal strength space division 300 that can be used to derive information regarding the expected call connectivity and/or the expected data rate. In various embodiments, the signal strength space division 300 may be determined based on an assumption that a voice call generally needs a certain minimum signal strength 350 (e.g., −85 dBm) to be connected, wherein having a signal strength 350 above the required minimum may not substantially improve voice call connectivity and/or quality. However, the expected data rate may vary according to signal strength 350, whereby the expected data rate (and thus expected quality) for a data call can be expected to increase with the signal strength 350.

Accordingly, the example signal strength space division 300 shown in FIG. 3 divides possible values for the signal strength 350 into several regions 312, 322, 332, 342, etc. based on certain threshold/boundary values 310, 320, 330. In various embodiments, the threshold/boundary values 310, 320, 330 may be initialized with certain theoretical values, which may be determined according to a mean opinion score (MOS) or any other suitable known or future-developed technique(s). For example, in various embodiments, the threshold values 310, 320, 330, etc. may be initialized or later calibrated based on a MOS at a given location, a given signal strength, etc. Furthermore, the threshold/boundary values 310, 320, 330 may be appropriately recalibrated based on actual call performance. For example, in various embodiments, a user may provide feedback during and/or after a call to indicate the perceived quality for a voice call, whereby one or more of the thresholds 310, 320, 330, etc. may be increased in response to the user indicating that the perceived quality was better than expected. Conversely, one or more of the thresholds 310, 320, 330, etc. may be decreased in response to the user indicating that the perceived quality was worse than expected. Furthermore, the actual call performance may be determined based on one or more channel parameters such as a channel quality indicator (CQI), an actual data call speed or data call rate, etc. Accordingly, the measured channel parameters can be compared to the expected data rate (or other channel parameters) and one or more of the thresholds 310, 320, 330, etc. may be suitably adjusted to ensure that the expected data rate(s) in the regions 312, 322, 332, 342 are aligned with the actual performance experienced during the call(s).

In various embodiments, as mentioned above, the signal strength space division 300 may be used to predict the expected connectivity associated with a voice call, the expected quality associated with the voice call, the expected connectivity associated with a data call, and the expected data rate associated with the data call. For example, based on the assumption that the signal strength 350 has to be above a certain minimum value to be connected (e.g., −85 dBm), the first threshold 310 may be initialized with a value based on the minimum signal strength 350 needed to connect a voice call. As such, when the current signal strength 350 from a particular wireless network is below the first threshold 310, the current signal strength 350 may fall into a poor signal region 312. In such a case, user feedback may be provided in the form of voice output, displayed information, etc. to indicate that a voice call is not expected to be connectable. Furthermore, based on the assumption that a signal strength 350 above the minimum to connect the voice call may not substantially improve voice call connectivity and/or quality, the user feedback provided when the current signal strength 350 is above the first threshold 310 may indicate that the voice call is expected to be connectable.

In various embodiments, the user feedback may similarly indicate that a data call is not expected to be connectable when the current signal strength 350 from a particular wireless network is below the first threshold 310 and therefore falls into the poor signal region 312, while being connectable when the signal strength 350 exceeds the first threshold 310. However, because the expected data rate can be expected to vary according to changes in the signal strength 350, the user feedback may indicate different expected call qualities for the data call depending on the particular value for the current signal strength 350. For example, when the current signal strength 350 is between the first threshold 310 and a second threshold 320, the signal strength 350 may be moderate and a poor rate/quality is expected for the data call. When the current signal strength 350 is between the second threshold 320 and a third threshold 330, the signal strength 350 may be good and a good data rate/data call quality may be expected. When the current signal strength 350 exceeds the third threshold 330, the signal strength 350 may be excellent and an excellent data rate/data call quality can be expected. As such, in various embodiments, the second threshold 320 may be considered a data call threshold in the sense that the data call may not be worthwhile to conduct at a poor data rate even though the data call may be literally connectable. Accordingly, in various embodiments, voice feedback, display-based message feedback, etc. may be given to a user prior to a call based on the expected call connectivity and/or quality. For example, when the user requests a voice call while the current signal strength 350 is below the first threshold 310 or a data call while the current signal strength 350 is below the second threshold 320, feedback may be provided to inform the user that the call is unlikely to be connectable and/or to request confirmation to proceed with the call despite the fact that poor connectivity and/or quality is expected.

Furthermore, according to various embodiments, the concepts underlying the signal strength space division 300 can be suitably applied to multiple wireless signals from multiple wireless networks that are associated with different SIMs on a given device. Accordingly when the device has multiple SIM cards and the signal strength space division 300 is used to provide the user with the expected call connectivity and/or quality prior to the call, the user may thereby select one particular SIM card based on the information indicating the predicted quality of service. Furthermore, the user may choose whether to initiate a voice call and/or a data call based on the expected connectivity associated with each and the expected quality associated with each. For example, the user may not attempt a data call that needs high quality of service (e.g., live streaming) when the current signal strength 350 is in the moderate signal region 322 or the good signal region 332 even though the data call is likely to be connectable.

Those skilled in the art will appreciate that although the signal strength space division 300 is shown in FIG. 3 as having four regions 312, 322, 332, 342 divided according to three threshold values 310, 320, 330, more or fewer regions and/or threshold values may be suitably employed. Furthermore, although the foregoing description notes that the threshold values 310, 320, 330 may be initialized or recalibrated based on a MOS at a given location, a given signal strength, etc., those skilled in the art will appreciate that other suitable voice quality scores or measurements can be used instead and/or in addition to the MOS. Further still, while the various regions 312, 322, 332, 342 are shown in FIG. 3 as approximately equal and divided according to approximately equidistant threshold values 310, 320, 330, those skilled in the art will appreciate that the intervals between the threshold values 310, 320, 330 need not be identical. For example, there may be a larger difference between the voice call threshold 310 and the data call threshold 320 than between the data call threshold 320 and the third threshold 330 dividing good from excellent call quality.

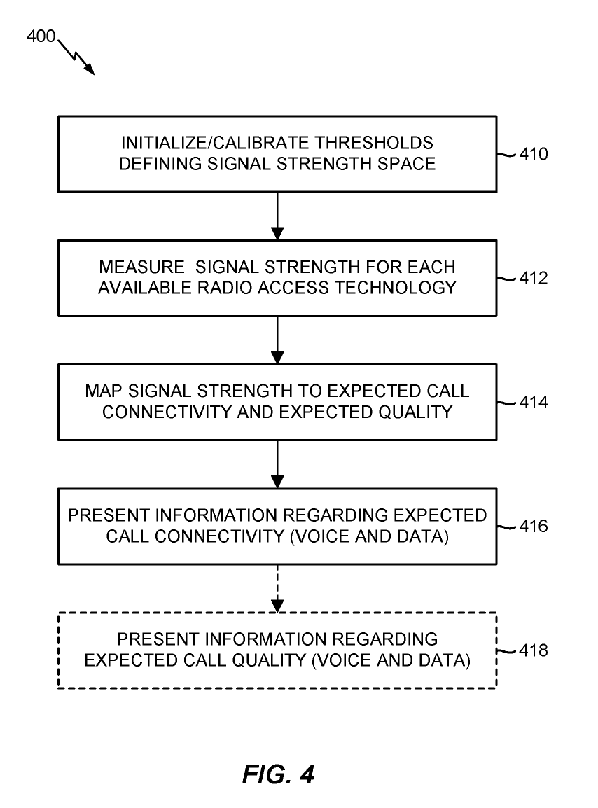

According to various aspects, FIG. 4 illustrates an exemplary method 400 that may be carried out to provide a user pre-call feedback regarding expected connectivity and/or expected quality. More particularly, at block 410, various thresholds defining a signal strength space may be initialized or otherwise suitably calibrated. In various embodiments, the signal strength space division may be initialized based on certain theoretical values with respect to voice call connectivity, voice call quality, data call connectivity, data call quality, etc. For example, in various embodiments, the theoretical values may include a first threshold value representing a certain minimum signal strength that is expected to be needed to connect a voice call. In other examples, the theoretical values may further divide the signal strength space into one or more regions based on mean opinion score (MOS) information regarding expected call quality at a given location, a given signal strength, or otherwise (e.g., based on a network coverage map indicating the MOS at various locations, the MOS at various signal strengths, or according to any other parameters used to measure the MOS information). In still other examples, the theoretical values used to initialize the thresholds defining the signal strength space may include one or more threshold values based on the expected data rate (and thus the expected quality associated with a data call) as a function of signal strength. Accordingly, in various embodiments, the threshold values may divide the signal strength space into regions defining different expected data rates. Furthermore, as noted above, the threshold values that define the signal strength space may be suitably calibrated based on actual performance. For example, when a user makes a voice call or a data call, the device may learn one or more parameters regarding the operating environment and adjust the threshold values as appropriate. In other examples, the user may provide implicit and/or explicit feedback after the call to indicate the perceived quality and the threshold values may be appropriately adjusted based on the user feedback. Of course, those skilled in the art will appreciate that other suitable techniques to initialize/calibrate the threshold values may be suitably employed. In any case, the threshold values may be used to divide the signal strength space into various regions, including one or more regions in which a voice call is expected to be connectable, one or more regions in which a data call is expected to be connectable, one or more regions that correspond to an expected voice call quality, one or more regions that correspond to an expected data rate (and thus expected data call quality), and so on.

In various embodiments, at block 412, a signal strength for each available radio access technology (RAT) may be measured according to mechanisms that are generally standardized per each available RAT. Furthermore, in various embodiments, the signal strength that is measured at block 412 may include measurements associated with multiple subscriber identity module (SIM) cards on a multi-SIM device. In various embodiments, the instantaneous signal strength may be measured and filtered over a given time duration at block 412 (e.g., a few seconds or another suitable period that enables the signal strength to be measured over time, including filtering out measurements that appear to be brief fluctuations in the environment, etc.). In various embodiments, the signal strength may then be mapped to an expected call connectivity and an expected call quality at block 414. In particular, the signal strength associated with a given RAT on a given SIM card may be mapped to an appropriate region within the signal strength space associated with the given RAT. The region mapped to the signal strength may be associated with an expected voice call connectivity, an expected voice call quality, an expected data call connectivity, and an expected data rate. Furthermore, as noted above, further levels of granularity may be possible, including variations in the expected connectivity/quality based on location, time, or any other suitable variable that may affect performance in a wireless network.

In various embodiments, at block 416, information regarding the expected call connectivity may be presented to the user. For example, in various embodiments, the threshold values that are defined at block 410 may include a threshold value representing a minimum signal strength needed to connect a voice call. As such, in various embodiments, the information presented at block 416 may indicate that a voice call is likely to be connectable if the signal strength is above the minimum signal strength needed to connect the voice call. Furthermore, the information presented at block 416 may indicate whether a data call is likely to be connectable based on an expected data rate mapped to the current signal strength. For example, a data call may involve live video streaming or other activities that have greater data requirements than a voice call. As such, in various embodiments and depending on context, information may be presented at block 416 regarding the likelihood that a data call will successfully connect for the intended purpose(s). In various embodiments, the information may be presented at block 416 via voice outputs, messages displayed on a screen, etc.

In various embodiments, at block 418, information regarding the expected call quality may optionally be presented to the user. For example, in various embodiments, the expected call quality may be presented via voice outputs, message interactions, displayed content, or in other ways in response to a determination that a voice call and/or a data call is likely to have connectivity based on the current signal strength. For a voice call, the expected call quality may be determined based on a MOS at a given signal strength, a given location, a given time, and/or suitable combinations thereof. For a data call, the expected call quality may be determined based on an expected data rate mapped to the given signal strength, the given location, the given time, and/or suitable combinations thereof. As such, in various embodiments, presenting the information regarding the expected voice/data call connectivity as well as the optional information regarding the expected call quality prior to the user making the call may offer several advantageous aspects. For example, the user may know when there is a possibility that a call will be dropped prior to making the call, whereby the user may defer making the call until a later time when signal strength is better to avoid the call drop, attempt the call from another location where the signal strength may be better, be prepared to handle the situation if/when the call drop occurs, or otherwise have an enhanced experience. In another example, the user can manage data requirements before making the call (e.g., not attempting a data call that would involve live video streaming where the expected data rate is poor). Furthermore, in a multi-SIM device, the information regarding the expected call connectivity/quality may be presented per-SIM card, whereby the user may choose one or more particular SIM cards to use when making the call based on which offer(s) the best expected connectivity and/or quality.

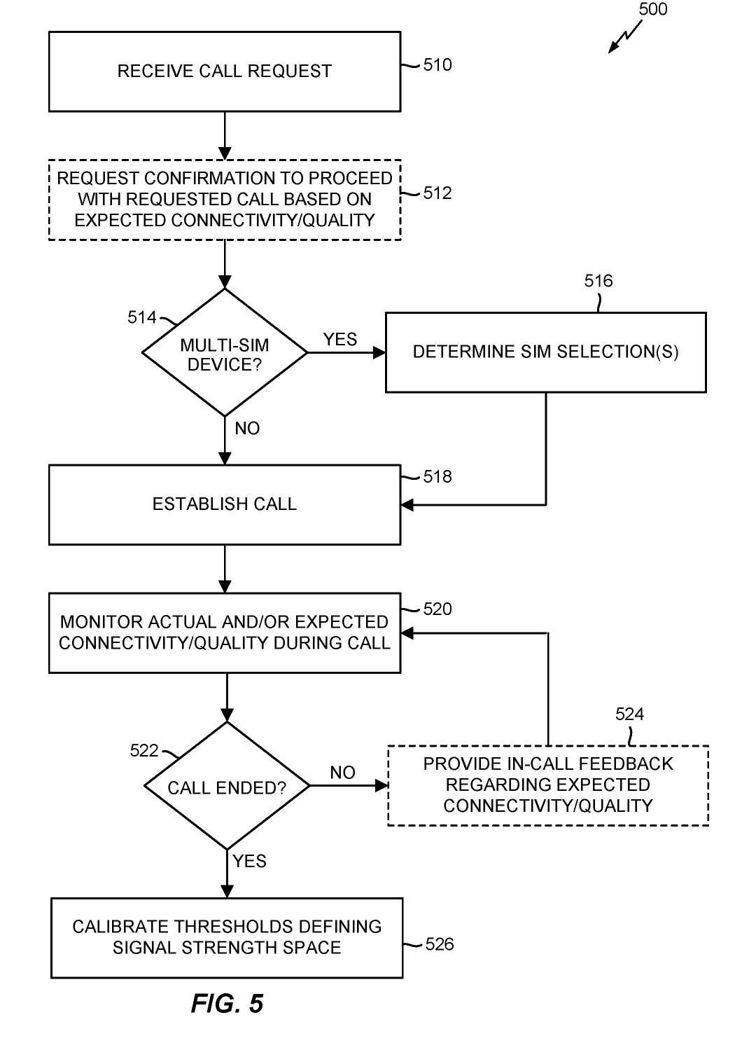

According to various aspects, FIG. 5 illustrates an exemplary method 500 to provide a user in-call feedback regarding expected connectivity and/or expected quality. More particularly, at block 510, a wireless device may receive a call request from a user. In various embodiments, the user may initiate the call request according to information that was presented via voice or message outputs to indicate the expected connectivity and/or expected quality associated with a voice call and a data call (e.g., based on a mapping to the current signal strength on a per-RAT, per-SIM basis). The user may therefore choose to request a voice call or a data call, which may be handled in different ways both on the wireless network and the wireless device. Accordingly, a request to confirm that the wireless device should proceed with the requested call may optionally be presented to the user at block 512 (e.g., via voice or message outputs). For example, in various embodiments, the confirmation request may be presented where the user requests a voice call and the current signal strength is below a certain minimum threshold value needed to connect the voice call. Alternatively, in other embodiments, the confirmation request may be presented where the user requests a data call and the current signal strength maps to a data rate below that which is expected to be necessary to support any requirements associated with the data call (e.g., data requirements to stream video). The method 500 as shown in FIG. 5 may therefore optionally end at block 512 in the event that the user indicates that the call should not proceed.

In various embodiments, upon determining that suitable conditions to proceed with the call exist, a determination may then be made at block 514 as to whether the wireless device is a multi-SIM device. In the affirmative, at block 516, one or more SIM selections may be determined. For example, the user may be presented with information regarding the expected connectivity and/or quality associated with voice and/or data calls on a per-RAT, per-SIM basis. The user may further be given the option to choose one or more SIMs to use when making the call, wherein the user may consider the expected connectivity and/or quality when choosing the one or more SIMs. In the alternative, in various embodiments, one or more SIMs likely to offer the best performance may be automatically selected without user input based on the data and system analysis underlying the connectivity/quality information presented to the user.

In various embodiments, the requested call may be suitably established at the wireless device at block 518. The actual and/or expected connectivity/quality may then be monitored during the call at block 520. For example, at block 520, the wireless device may continue to measure the current signal strength and map the measured current signal strength to the corresponding expected connectivity/quality. Furthermore, for a data call, additional parameters can be measured to determine an actual data rate as compared to the data rate that was expected (e.g., based on quantities relating to data transmitted/received via uplink and downlink connections). In various embodiments, the wireless device may determine whether the call has ended at block 522. In response to determining that the call has not ended, in-call feedback regarding the expected connectivity/quality may optionally be presented to the user at block 524. For example, in various embodiments, the in-call feedback may be presented when the signal strength crosses below a threshold value such that the call is more likely to be dropped. In another example, the in-call feedback may be presented to the user in response to determining that a radio link failure (RLF) timer has started such that the user can attempt to take action to prevent the RLF from occurring. In particular, RLF generally happens only after the RLF timer has expired. Accordingly, providing the notice that the RLF timer has started before expiration may give the user the opportunity to move to a better location or take other remedial action to prevent the RLF from occurring.

According to various embodiments, at some point in time the call will suitably end, at which time the wireless device may (re)calibrate the threshold values that define the signal strength space associated with each available RAT at block 526. For example, when the call ends, the wireless device may learn one or more parameters regarding the operating environment and adjust the threshold values as appropriate and at least partially based on whether the call was a voice call or a data call. In other examples, the user may provide feedback after the call to indicate the perceived quality and the threshold values may be appropriately adjusted based on the user feedback. Of course, those skilled in the art will appreciate that other suitable techniques to initialize/calibrate the threshold values may be suitably employed at block 526.

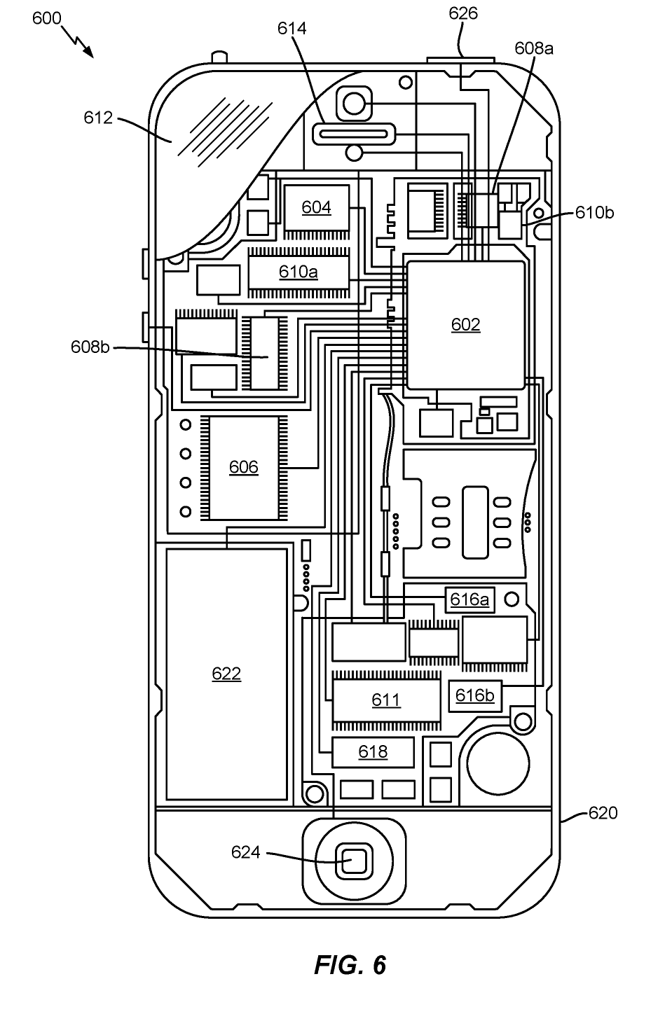

According to various aspects, FIG. 6 illustrates an exemplary mobile device 600 suitable for use in accordance with the various aspects and embodiments described herein. For example, in various embodiments, the mobile device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, a display of the mobile device need not have touchscreen capabilities.

The mobile device 600 may have one or more cellular network transceivers 608a, 608b coupled to the processor 602 and to two or more antennae 610a, 610b and configured to send and receive cellular communications over one or more wireless networks. The transceivers 608a, 608b and antennae 610a, 610b may be used with the above-mentioned circuitry to implement the various aspects and embodiment described herein. In various embodiments, the cellular network transceivers 608a, 608b may respectively correspond to the RF resources 218a, 218b shown in FIG. 2. Furthermore, the antennae 610a, 610b may respectively correspond to the wireless antennae 220a, 220b as shown in FIG. 2. The mobile device 600 may also include two or more SIM cards 616a, 616b respectively corresponding to SIM-1 204a and SIM-2 204b shown in FIG. 2, wherein the SIM cards 616a, 616b may be coupled to the transceivers 608a, 608b and/or the processor 602. The mobile device 600 may include a cellular network wireless modem chip 611 (e.g., the baseband processor 216 in FIG. 2), which may enable communication via a cellular network and be coupled to the processor 602.

In various embodiments, the mobile device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not explicitly shown in FIG. 6).

In various embodiments, the mobile device 600 may also include one or more speakers 614 to provide audio outputs. The mobile device 600 may also include a housing 620, which may be constructed of a plastic, metal, or a combination of materials, to contain all or one or more of the components discussed herein. The mobile device 600 may include a power source 622 coupled to the processor 602, such as a disposable or rechargeable battery. The rechargeable battery 622 may also be coupled to the peripheral device connection port (not shown) to receive a charging current from a source external to the mobile device 600. The mobile device 600 may also include a physical button 624 configured to receive user inputs and a power button 626 configured to turn the mobile device 600 on and off.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method for predicting call connectivity, comprising:
measuring, at a wireless device, a current signal strength for at least one radio access technology (RAT);
mapping, at the wireless device, the current signal strength to a signal strength space division having multiple regions, wherein the multiple regions are each associated with an expected voice call connectivity and an expected data call connectivity; and
presenting, at the wireless device, user feedback information that indicates the expected voice call connectivity and the expected data call connectivity prior to receiving a request to initiate a call from the user.

2. The method recited in claim 1, wherein the user feedback information indicates the expected voice call connectivity and the expected data call connectivity for multiple subscriber identity module (SIM) cards having subscriptions on the wireless device.

3. The method recited in claim 2, further comprising:
receiving, at the wireless device, the request to initiate the call from the user, wherein the request indicates a selection of at least one of the multiple SIM cards;
determining a type of the call from among a voice call and a data call; and
handling the request to initiate the call based at least in part on the current signal strength and the type of the call.

4. The method recited in claim 3, wherein handling the request to initiate the call based at least in part on the current signal strength and the type of the call comprises:
establishing the call in response to determining that the current signal strength exceeds a threshold value defined in the signal strength space division to separate a first region in which the type of the call is expected to have connectivity from a second region in which the type of the call is not expected to have connectivity.

5. The method recited in claim 4, wherein handling the request to initiate the call based at least in part on the current signal strength and the type of the call comprises:
presenting, at the wireless device, a request to confirm whether to proceed with the requested call in response to determining that the current signal strength does not exceed the threshold value such that the current signal strength is mapped to the second region in which the type of the call is not expected to have connectivity.

6. The method recited in claim 1, wherein the user feedback information is presented via one or more of a voice output or a displayed output.

7. The method recited in claim 1, wherein the multiple regions in signal strength space division comprise at least one region in which a voice call is not expected to connect and one or more regions in which a voice call is expected to connect, and wherein the at least one region is separated from the one or more regions according to a threshold value based on a minimum signal strength needed to connect a voice call.

8. The method recited in claim 1, wherein the multiple regions in signal strength space division are each further associated with an expected voice call quality based at least in part on mean opinion score (MOS) information and an expected data call quality based at least in part on an expected data rate at a given signal strength.

9. The method recited in claim 8, further comprising:
receiving, at the wireless device, the request to initiate the call from the user;
determining a type of the call from among a voice call and a data call; and
presenting, at the wireless device, in-call feedback information that indicates the expected connectivity and the expected quality associated with the call based on changes in the current signal strength and the type of the call.

10. The method recited in claim 9, further comprising:
determining, at the wireless device, that a radio link failure (RLF) timer has started, wherein the in-call feedback information is presented to inform the user that the RLF timer has started prior to the RLF timer having expired.

11. The method recited in claim 9, wherein the in-call feedback information indicates the expected connectivity and the expected quality with respect to multiple subscriber identity module (SIM) cards having subscriptions on the wireless device.

12. The method recited in claim 8, further comprising:
receiving, at the wireless device, the request to initiate the call from the user;
determining a type of the call from among a voice call and a data call; and
calibrating, at the wireless device, one or more threshold values used to separate the multiple regions in the signal strength space division in response to determining that the call has ended, wherein the one or more threshold values are calibrated based at least in part on the type of the call and actual performance during the call.

13. The method recited in claim 12, wherein the actual performance during the call is determined according to user feedback received after the call to indicate a perceived quality during the call.

14. The method recited in claim 12, wherein the actual performance during the call is determined according to one or more channel parameters measured during the call.

15. A wireless device, comprising:
at least one radio frequency (RF) resource configured to measure a current signal strength for at least one radio access technology (RAT);
at least one processor configured to map the current signal strength to a signal strength space division having multiple regions, wherein the multiple regions are each associated with an expected voice call connectivity and an expected data call connectivity; and
at least one output device configured to present user feedback information that indicates the expected voice call connectivity and the expected data call connectivity, the user feedback information presented prior to receiving a request to initiate a call from the user.

16. The wireless device recited in claim 15, further comprising multiple subscriber identity module (SIM) cards that are associated with subscriptions on the wireless device, wherein the user feedback information indicates the expected voice call connectivity and the expected data call connectivity for the multiple SIM cards.

17. The wireless device recited in claim 16, wherein the at least one processor is further configured to:
receive the request to initiate the call from the user, wherein the request indicates a selection of at least one of the multiple SIM cards;
determine a type of the call from among a voice call and a data call; and
handle the request to initiate the call based at least in part on the current signal strength and the type of the call.

18. The wireless device recited in claim 17, wherein the at least one processor is further configured to establish the call in response to the current signal strength exceeding a threshold value defined in the signal strength space division to separate a first region in which the type of the call is expected to have connectivity from a second region in which the type of the call is not expected to have connectivity.

19. The wireless device recited in claim 18, wherein the at least one processor is further configured to present, via the at least one output device, a request to confirm whether to proceed with the requested call in response to the current signal strength not exceeding the threshold value such that the current signal strength is mapped to the second region in which the type of the call is not expected to have connectivity.

20. The wireless device recited in claim 15, wherein the at least one output device comprises one or more of a speaker configured to present the user feedback information as a voice output or a display device configured to present the user feedback information as a displayed output.

21. The wireless device recited in claim 15, wherein the multiple regions in signal strength space division comprise at least one region in which a voice call is not expected to connect and one or more regions in which a voice call is expected to connect, and wherein the at least one region is separated from the one or more regions according to a threshold value based on a minimum signal strength needed to connect a voice call.

22. The wireless device recited in claim 15, wherein the multiple regions in signal strength space division are each further associated with an expected voice call quality based at least in part on mean opinion score (MOS) information and an expected data call quality based at least in part on an expected data rate at a given signal strength.

23. The wireless device recited in claim 22, wherein the at least one processor is further configured to:
receive the request to initiate the call from the user;
determine a type of the call from among a voice call and a data call; and
present, via the at least one output device, in-call feedback information that indicates the expected connectivity and the expected quality associated with the call based on changes in the current signal strength and the type of the call.

24. The wireless device recited in claim 23, wherein the at least one processor is further configured to determine that a radio link failure (RLF) timer has started, wherein the in-call feedback information is presented to inform the user that the RLF timer has started prior to the RLF timer having expired.

25. The wireless device recited in claim 23, further comprising multiple subscriber identity module (SIM) cards that are associated with subscriptions on the wireless device, wherein the in-call feedback information indicates the expected connectivity and the expected quality with respect to the multiple SIM cards.

26. The wireless device recited in claim 22, wherein the at least one processor is further configured to:
receive the request to initiate the call from the user;
determine a type of the call from among a voice call and a data call; and
calibrate one or more threshold values used to separate the multiple regions in the signal strength space division in response to the call ending, wherein the one or more threshold values are calibrated based at least in part on the type of the call and actual performance during the call.

27. The wireless device recited in claim 26, wherein the actual performance during the call is determined according to user feedback received after the call to indicate a perceived quality during the call.

28. The wireless device recited in claim 26, wherein the actual performance during the call is determined according to one or more channel parameters measured during the call.

29. A wireless device, comprising:
means for measuring a current signal strength for at least one radio access technology (RAT);
means for mapping the current signal strength to a signal strength space division having multiple regions, wherein the multiple regions are each associated with an expected voice call connectivity and an expected data call connectivity; and
means for presenting user feedback information that indicates the expected voice call connectivity and the expected data call connectivity prior to receiving a request to initiate a call from the user.

30. A computer-readable storage medium having computer-executable instructions recorded thereon, the computer-executable instructions configured to cause a wireless device to:
measure a current signal strength for at least one radio access technology (RAT);
map the current signal strength to a signal strength space division having multiple regions, wherein the multiple regions are each associated with an expected voice call connectivity and an expected data call connectivity; and
present user feedback information that indicates the expected voice call connectivity and the expected data call connectivity prior to receiving a request to initiate a call from the user.
